(19) United States
(12) Patent Application Publication
(10) Pub. No.: US 2005/0093818 A1
(43) Pub. Date: May 5, 2005

(54) Dynamic laser projection display

(75) Inventors: Shahab Hatam-Tabrizi, San Jose, CA (US); Wei-Hung Yeh, Fremont, CA (US); Mansur Bashardoust, Cupertino, CA (US)

Correspondence Address: BURGESS & BEREZNAK LLP, 800 WEST EL CAMINO REAL, SUITE 180, MOUNTAIN VIEW, CA, 94040, US

(73) Assignee: Lightbay Networks Corporation, Fremont, CA (US)

(21) Appl. No.: 10/701,779

(22) Filed: Nov. 5, 2003

(51) Int. Cl. G09G 5/00

(52) U.S. Cl. 345/156

(57) ABSTRACT

A laser projection display apparatus includes a laser that emits a light beam. Actuators steer the light beam in horizontal and vertical directions to generate the display images. Each of the actuators includes first and second mirrors, each of which is suspended by a gimbal. Each of the mirrors rotates responsive to current flow through a coil attached to a backside of the mirror in the presence of a magnetic field. A digital signal process provides integrated control of the actuators and laser power based on the content of a display program. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### RELATED APPLICATIONS

This application is related to of Ser. No. 10/170,978 filed Jun. 13, 2002 entitled, “GIMBAL FOR SUPPORTING A MOVABLE MIRROR”.

### FIELD OF THE INVENTION

The present invention relates generally to apparatus and methods for light projection; more particularly, to optical systems that project laser light onto a screen, wall, or other object as part of an animated show or information display.

### BACKGROUND OF THE INVENTION

Modern light display systems exist in many different forms, and are implemented using a wide variety of technologies. Typical applications of light display devices include the projection display of visual information, such as for point-of-sale advertising, trade shows, corporate front-lobbies, conventions, entertainment venues (e.g., cinema projection of animated shows) and the display of various digital images. Other applications include raster-graphics data/video projection, consumer electronics devices, toys, and games.

Standard laser projection display systems commonly utilize a mirror mounted to a galvanometer for scanning image lines. Examples of image display systems that use a galvanometer mounted mirror are found in U.S. Pat. Nos. 6,621,615, 6,577,429, and 6,552,702. Other conventional scanning methods employ a spinning polygon or a rotating prism. The main drawback of these types of prior art display systems is that they rely upon relatively large, massive moving components. Due to the inertia associated with these components, a large amount of electrical power is generally required for actuation of the mirrors and other optical elements. Often times, cooling fans are required to dissipate the considerable heat that is generated.

The large mass and inertia also slows the response time, and hence, the performance, of the image display system. Slow movement of the laser beam, for example, makes it difficult to achieve real-time projection of high-resolution motion images. Prior art laser projectors also tend to be large, heavy, and thus lack portability. All of these drawbacks have made prior art laser display systems expensive to purchase and costly to operate.

Other types of existing display technologies, such as liquid crystal display (LCD) and digital light technology (DLT), operate with a fixed number of pixels, which limits both the size and the resolution of the image being displayed. Enhancing the size and resolution of the display screen can be costly, and image display speed typically suffers.

Another problem with prior art laser projection display systems is that servo control of the actuators used to move the laser beam is independent of program content of the moving image. In other words, synchronization of laser switching and servo positioning does not exist in present-day display systems. During display of an image the laser beam must be frequently turned off, and then back on again, in order to step the beam to a new scan or display position. To insure that the laser beam is not activated prior to completing the step, prior art laser projection systems operate under worst case condition assumptions. That is, if the range of the steps varies from 20 microseconds to 300 microseconds, the laser controller simply assumes a 300 microsecond step. The problem with such systems, therefore, is that for fast moving and/or high-resolution images light intensity dims significantly and performance suffers.

Thus, there is a need for a robust, economical, low-power display apparatus for laser projection of images that can provide improved performance for a wide variety of applications.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIGS. 1A & 1B are top perspective views of two different embodiments of the image display apparatus of the present invention.

FIG. 2 is a perspective view of the printed circuit board assembly and laser assembly in accordance with one embodiment of the present invention.

FIG. 3 is an exploded view of the laser assembly utilized in accordance with one embodiment of the present invention.

FIG. 4A is a top perspective view of the actuator assembly utilized in accordance with one embodiment of the present invention.

FIG. 4B an exploded view of the actuator assembly shown in FIG. 4A.

FIGS. 5A & 5B are side cross-sectional views of the actuator assembly shown in FIG. 4A, without the detector bracket assembly attached.

FIGS. 6A, 6B & 6C are respective side, bottom, and perspective exploded views of the mirror-gimbal assembly utilized in accordance with one embodiment of the present invention.

FIG. 7 is a cross-sectional side view of a magnet arrangement used in a mirror-gimbal assembly according to another embodiment of the present invention.

FIG. 8 is a perspective view of the detector bracket assembly utilized in accordance with one embodiment of the present invention.

FIG. 9 is a side cross-sectional view of the actuator assembly illustrated in FIG. 4A with the detector bracket assembly attached.

FIG. 10 a top perspective view of an actuator assembly utilized in accordance with an alternative embodiment of the present invention.

FIG. 11 is a side view of the actuator assembly of FIG. 10, showing details of the light detection apparatus.

FIGS. 12A & 12B are exemplary images that may be generated by the image display apparatus of the present invention.

FIG. 13 is a block diagram of the integrated electronics and firmware in accordance with one embodiment of the present invention.

### DETAILED DESCRIPTION

A laser projection display device for use in displaying a variety of still or animated images is described. In the following description numerous specific details are set forth, such as angles, material types, configurations, etc., in order to provide a thorough understanding of the present invention. However, persons having ordinary skill in the light projection and optical-electronics arts will appreciate that these specific details may not be needed to practice the present invention.

According to one embodiment of the present invention, a pair of actuator assemblies each having a mirror gimbal assembly are utilized to control the path of a laser beam to create line-art animation shows or other images that can be projected onto a screen, wall, or other object. By way of example, the laser display apparatus of the present invention may be used to project navigation, speed, or other information onto an area of an auto's windshield. The present invention also has numerous other consumer and industrial applications. For example, the present invention may be used for point-of-sale advertising, trade show displays, corporate front-lobby signs, helmet image display, toys, games, raster-graphics data/video displays, messaging, and mobile phone projection displays.

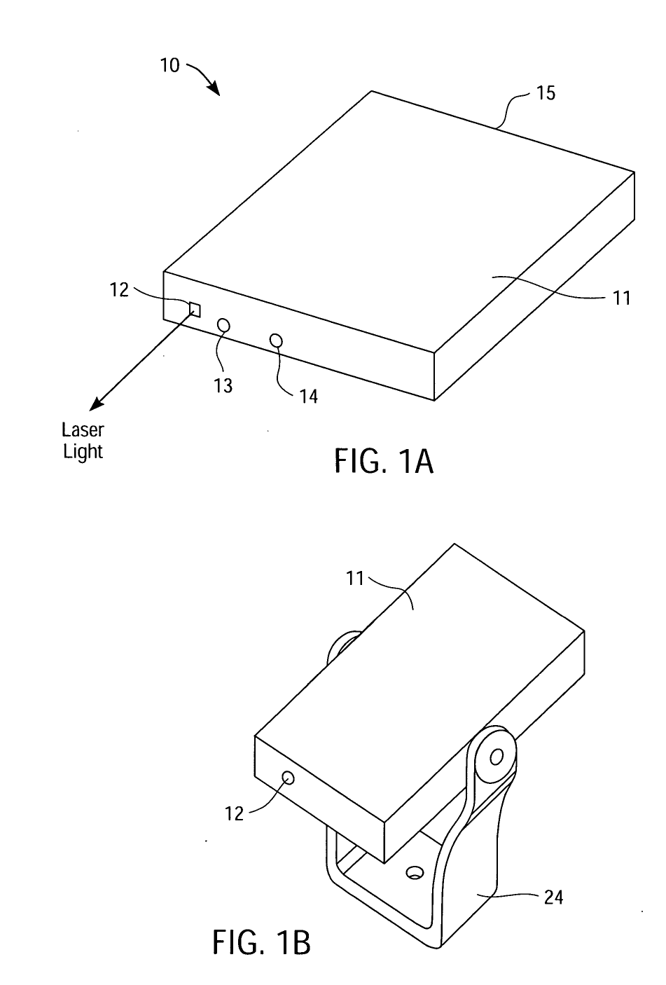

FIG. 1A is a perspective view of a laser projection display unit 10 in accordance with one embodiment of the present invention. In one implementation, display unit 10 comprises a box-like enclosure 11 that measures about 6×3×1 inches in size. Support legs or a mounting bracket (see FIG. 1B) may be attached to the bottom of enclosure 11. Content may be downloaded into display unit 10 from a computer or other device via an interface 15 located along the rear side of enclosure 11. Interface 15 may include a standard USB interface, serial interface, Ethernet interface, wireless connection, Firewire™ interface, etc. Display unit 10 may also be programmed and/or controlled with a handheld infrared (IR) remote device via IR input sensor 13. Display unit 10 may also include a keypad (not shown) located along a side or top of enclosure 11 for inputting display information or controlling the shows to be displayed.

In the embodiment of FIG. 1, laser light exits through an opening 12 located along a front side of enclosure 11. An optional power indication LED 14 may also be mounted to the front side of enclosure 11. Power may be supplied to display unit 10 through a standard power connector located, for example, on the rear side of enclosure 11. Alternatively, power may be supplied by an internal battery.

FIG. 1B illustrates an alternative embodiment in which enclosure 11 is moveably mounted to a U-shaped bracket 24. Bracket 24 may be pivoted about its base, and/or the display unit tilted up or down, in order to aim the projected laser image in a particular direction and surface.

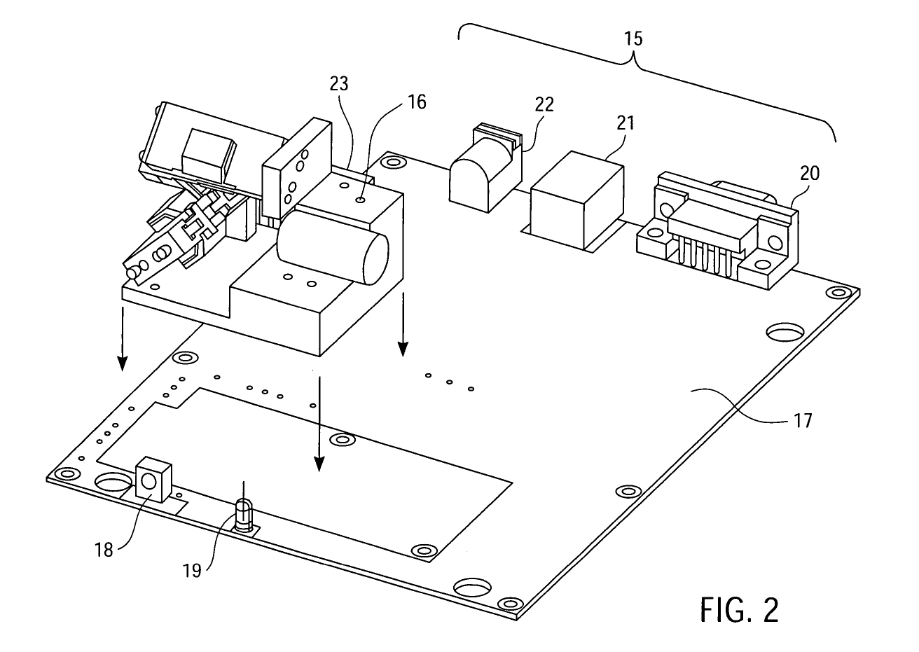

FIG. 2 is a perspective view of a printed circuit board assembly (PCBA) 17 and laser assembly 16 housed within enclosure 11 in accordance with one embodiment of the present invention. In the embodiment shown, a top cover (not shown) is attached to PCBA 17, so that PCBA 17 comprises the bottom of enclosure 11. Laser assembly 16 is mounted to PCBA 17 adjacent the front side where the projected laser beam exits the unit. Also mounted along the front side of PCBA 17 are power indication LED 14 and IR input sensor 13. A standard power connector 22, a USB interface connector 21, and a serial interface connector 20, which collectively comprise interface 15 in this example, are mounted along the rear side of PCBA 17. An on/off switch 23 (partially hidden from view by laser assembly 16) is also mounted along a side of PCBA 17 in the embodiment of FIG. 2.

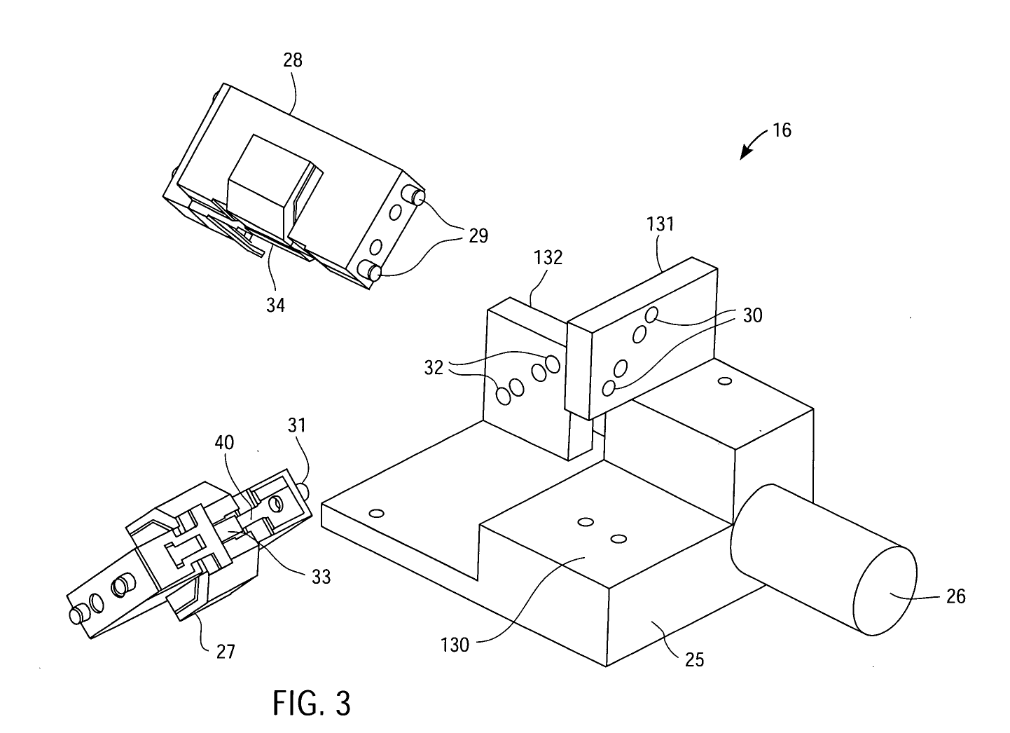

FIG. 3 is an exploded perspective view of laser assembly 16 in accordance with the embodiment of FIG. 2. Laser assembly 16 comprises a base 25, a barrel laser 26, and a pair of identical actuator assemblies 27 & 28. Laser 26 and actuator assemblies 27 & 28 are each mounted to various platform surfaces or block members of base 25. For example, laser 26 is mounted to platform surface 130, lower actuator assembly 27 is mounted to block member 132, and upper actuator assembly 28 is mounted to block member 131 of base 25. Base 25 is made of a durable, non-magnetic material, e.g., ceramic, polycarbonate/plastic, black anodized aluminum, etc.

In the embodiment of FIG. 3, actuator assemblies 27 & 28 are mounted in precision aligned positions with respect to one another and to laser 26 by means of a peg-to-hole mounting method. For instance, or pegs 29 on the side of actuator assembly 28 are adapted to align with and securely fit into corresponding holes 30 of upper block member 131. Similarly, pegs 31 (only one of which is visible in FIG. 3) are adapted to align with and securely fit into corresponding holes 32 of lower block member 132. Block members 131 and 132 are arranged with their primary side surfaces orthogonal to one another such that the respective longitudinal axes of actuator assemblies 27 and 28 are oriented in a perpendicular relationship.

Laser 26 may also be mounted to platform surface 130 of base 25 using a peg-to-hole alignment method. In one embodiment, laser 26 comprises an assembly manufactured by Arima Optoelectronics Corporation and commercially available as part no. ADL-63101. The assembly includes a collimating lens and a red laser diode that outputs approximately 5 mW of optical power. Other types of assemblies may be utilized, including different color (e.g., green or blue) color lasers.

Laser assembly 16 operates in the following manner. The laser beam produced by laser 26 travels horizontally (i.e., parallel to the bottom of base 25) until it strikes mirror 33 of lower actuator assembly 27. Actuator assembly 27 is oriented at about a 45° mechanical angle with respect to the direction of the laser beam emitted from laser 26. That means that mirror 33, which is mounted to a gimbal 40, is nominally oriented at about a 45° mechanical angle to the incoming/outgoing laser beam.

The flat, reflective surface of mirror 33 reflects the laser beam in an upward vertical direction (a 90° optical angle) where it strikes the gimbal-mounted mirror 34 of upper actuator assembly 28. Upper actuator assembly 28 is also oriented at about a 45° mechanical angle with respect to the direction of the incoming/outgoing laser beam, which means that mirror 34 of actuator assembly 28 is nominally oriented at about a 45° mechanical angle with respect to the direction of the incoming/outgoing laser beam. This mirror arrangement causes the laser beam to be reflected at a 90° optical angle, i.e., back to a horizontal direction where it then exits the enclosure through opening 12 (see FIG. 1).

Note that lower and upper actuator assemblies 27 & 28 are mounted to base 25 in a relationship wherein their longitudinal axes are perpendicular to one another. This relationship causes the laser beam to generally exit the display unit at about a 90° optical angle with respect to the direction that the laser beam is emitted from laser 26. To reiterate, the laser beam generated by laser 26 travels in a horizontal direction until it strikes mirror 33 of lower actuator assembly 27. Mirror 33 reflects the laser beam upward at about a 90° optical angle, where it then strikes mirror 34 of upper actuator assembly 28. Mirror 34 reflects the laser beam at a 90° optical angle back to a horizontal direction, where it exits the enclosure in a horizontal direction that is generally perpendicular to the direction of emission from laser 26.

Images are produced by laser assembly 16 by the combined rotational movements of mirrors 33 & 34 associated with respective lower and upper actuator assemblies 27 & 28. Each of mirrors 33 & 34 rotate about the longitudinal axis of their respective actuator assemblies under control of a software or firmware program executed by a computer or processor. By way of example, the program may rotate mirror 33 of actuator assembly 27 to perform a horizontal scan of the display image. Similarly, rotation of mirror 34 mounted on actuator assembly 28 performs a vertical scan of the display image. This aspect of the present invention is described in more detail below.

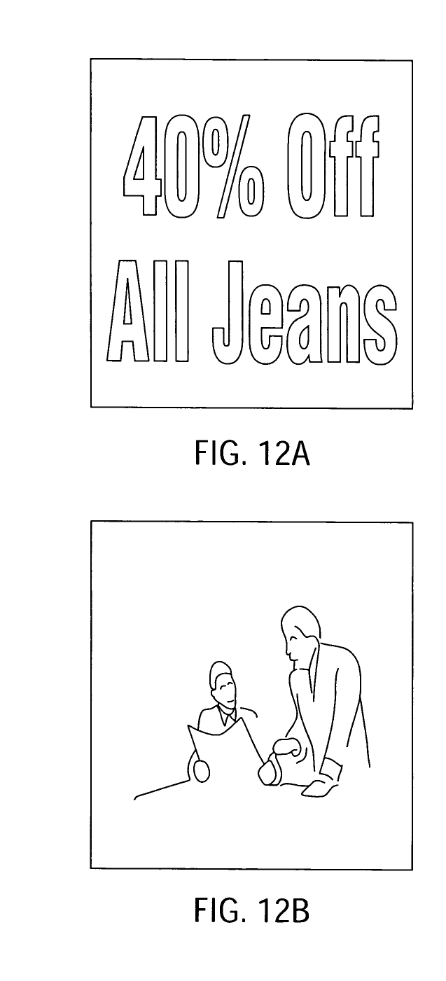

According to the present invention, users can convert images from programs such as 3ds, Max, Flash, and bitmap graphics to laser line-art format using a computer-based software program. Custom shows can also be created from new programs or through software editing. Graphics and programmed shows may be downloaded and stored in memory resident on the PCBA, for subsequent stand-alone display by remote command. FIGS. 12A & 12B are examples of just two of the types of images that may be produced by the laser projection display apparatus of the present invention.

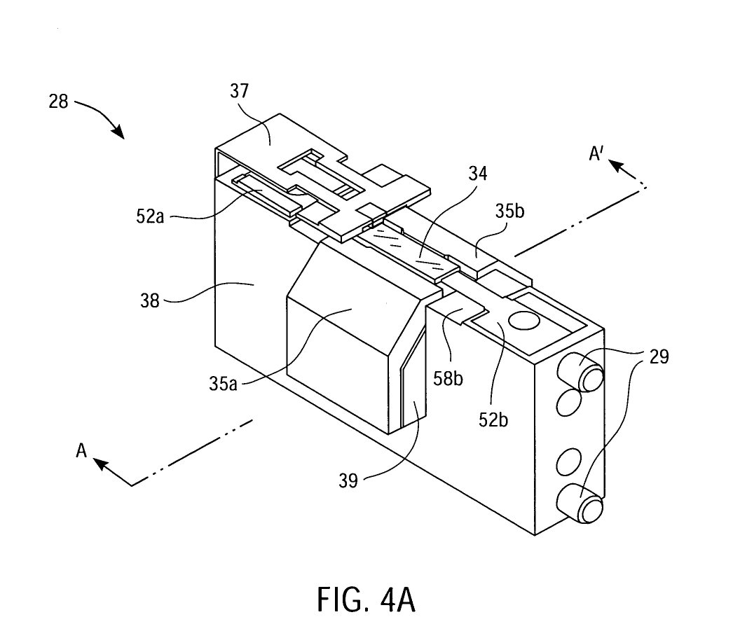

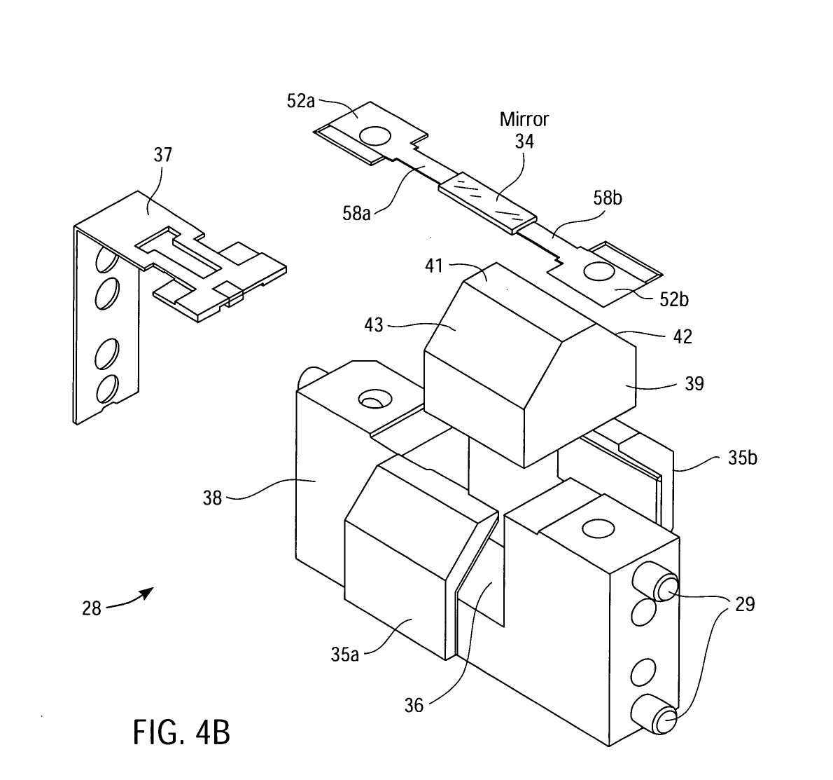

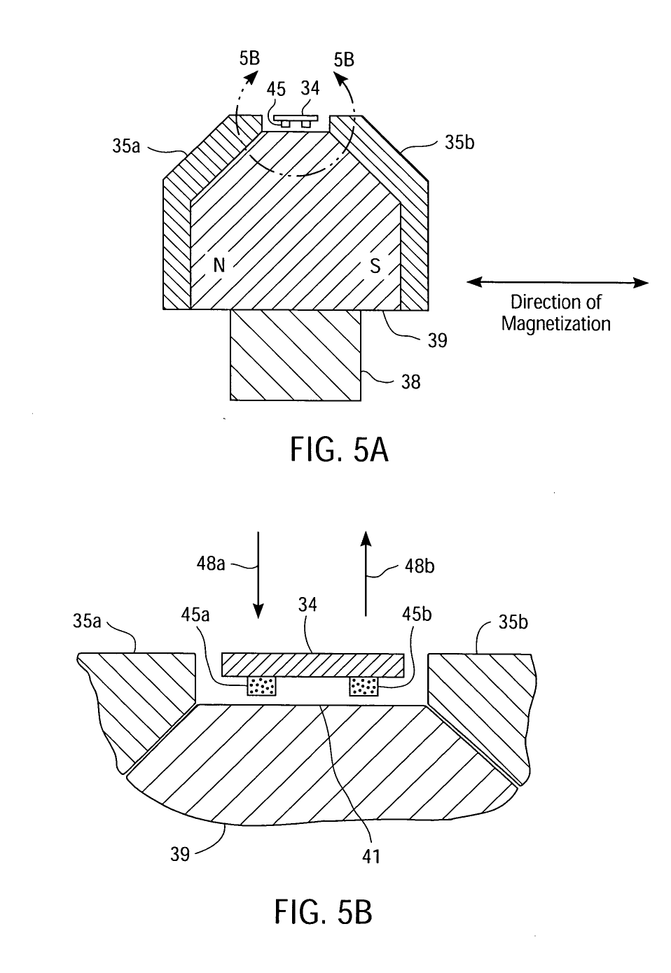

FIG. 4A is a top perspective view of actuator assembly 28. FIG. 4B is an exploded view of actuator assembly 28, which is identical to assembly 27 according to one embodiment of the present invention. Assembly 28 comprises an elongated rectilinear actuator block 38 made of an electrically non-conductive material, such as a polycarbonate/plastic material, or anodized aluminum. A pair of pegs 29 is arranged spaced-apart on a proximate end of block 38 for mounted insertion into holes 30 of block 131 (see FIG. 3) as previously described. A six-sided (see cross-section of FIGS. 5A & 5B) permanent magnet 39 having a trapezoid-shaped top portion, which includes angled (e.g., ˜45°) upper side surfaces 42 & 43 and a narrow top surface 41, is mounted directly below mirror 34 within a centrally-located opening 36 of actuator block 38. A pair of flux return plates 35a & 35b (e.g., magnetic stainless steel or low-carbon steel) are affixed to the respective left and right sides of magnet 39. In one implementation, magnet 39 comprises a neodymium boron iron magnet.

Practitioners in the art will appreciate that the trapezoidal geometry of magnet 39 permits the generation of a relatively large magnetic field in a small space. Specifically, the trapezoidal shape of magnet 39, which includes angled side surfaces 42 & 43 leading to narrow top surface 41, allows actuator assemblies 27 & 28 to be mounted in close proximity to one another on block 25. The close proximity between assemblies 27 & 28 means that the distance between mirrors 33 & 34 is minimized, which reduces problems associated with beam-mirror alignment. Minimizing the distance between mirrors 33 & 34 also means that the smaller mirrors may be utilized, which translates to increased performance. The larger the distance between mirrors 33 & 34, the larger the mirror required, which means that larger magnet fields and/or larger actuator currents are needed, all of which has an adverse impact on display performance.

Mirror-gimbal assembly 40 includes a mirror 34 bonded to a gimbal having ends 52a & 52b mounted to opposite ends of the top surface of actuator block 38. The gimbal suspends mirror 34 in a space between plates 35a & 35b above top surface 41 of magnet 39. This structural relationship is shown in the cross-sectional view of FIGS. 5A & 5B taken through cut lines A-A′. FIGS. 5A & 5B also illustrate a cross-section of a “racetrack” wire coil 45 attached to the bottom of mirror 34. The direction of magnetization of magnet 39 is such that magnetic flux lines pass through the space between plates 35a & 35b above top surface 41 in a direction perpendicular to the long axis of coil 45. That is, the magnetic field produced by magnet 39 is perpendicular to the longitudinal axis of the coil and parallel to the top, reflective surface of mirror 34.

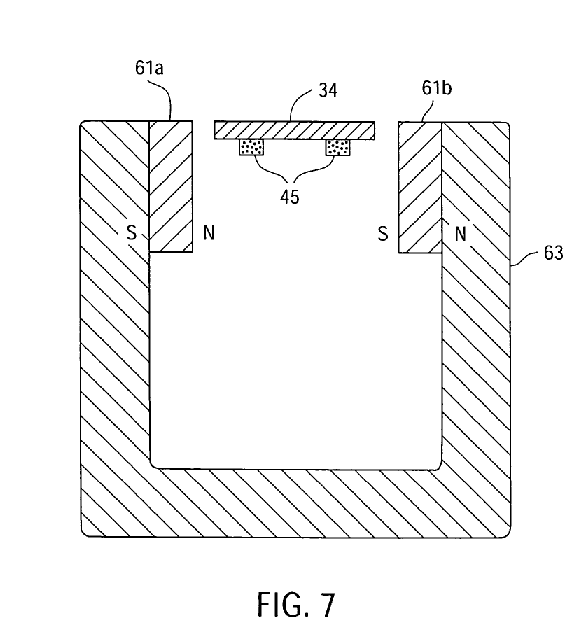

FIG. 7 is a cross-sectional side view of an alternative embodiment characterized by a magnet-return assembly that includes a pair of permanent magnets 61a & 61b mounted to opposite ends of the inside surface of a U-shaped flux return member 63 (e.g., steel). Magnets 61a & 61b and flux return member 63 are configured to produce a magnetic field with flux lines that are perpendicular to the longitudinal axis of coil 45 and parallel to the top, reflective surface of mirror 34.

Torque is developed on the mirror-coil assembly upon application of an appropriate current through coil 45 in the presence of the magnetic field produced by magnet 39. Current flow through coil 45 causes mirror 34 to rotate along the long axis of actuator assembly 28. The direction of current flow determines the direction of rotation, with the magnitude of the current determining the angle of rotation. By way of example, with the direction of the current flow in FIG. 5B being out of the paper in coil section 45a (i.e., the left side cross-section), and into the paper in coil section 45b (i.e., the right side cross-section), a rotational force is generated which raises the right side (the upward vertical force component is shown by arrow 48b) and lowers the left side (the downward vertical force component shown by arrow 48a) of mirror 34. Thus, the vertical component of force produced as the current travels through coil 45 has opposing directions on opposite sides (along the transverse axis) of mirror 34. This results in rotation of mirror 34. Stated differently, the direction of the force is made to be opposite on each side of the mirror-coil assembly such that the resulting torque rotates or tilts the mirror attached to the gimbal. A reverse current flow in coil 45 (into coil section 45a and out of coil section 45b) generates a rotational force in the opposite rotational direction. When the applied current is interrupted or halted, the restoring spring force of the gimbal returns the assembly to a rest position (i.e., mirror 34 at 0° rotation). It is appreciated that the elongated gimbal beams 58a & 58b of mirror-gimbal assembly 40 twists to accommodate rotation of mirror 34.

With reference once again to FIGS. 4A & 4B, an L-shaped detector bracket assembly 37 is attached to a distal end of block 38 using a peg-in-hole method. Detector bracket assembly 37 is utilized to detect the angle of rotation of mirror 34, as described in more detail below.

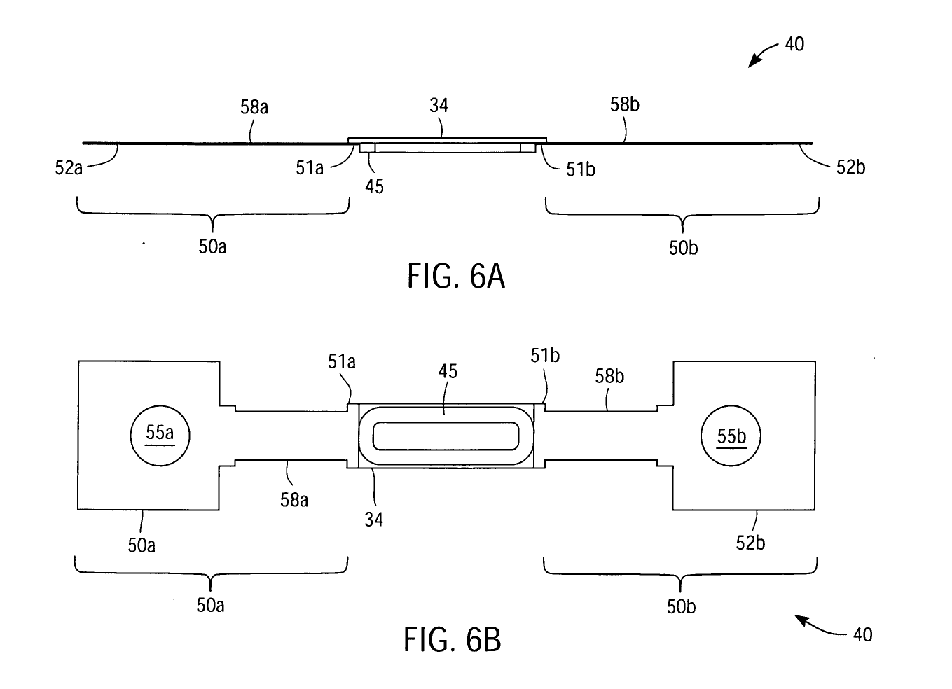

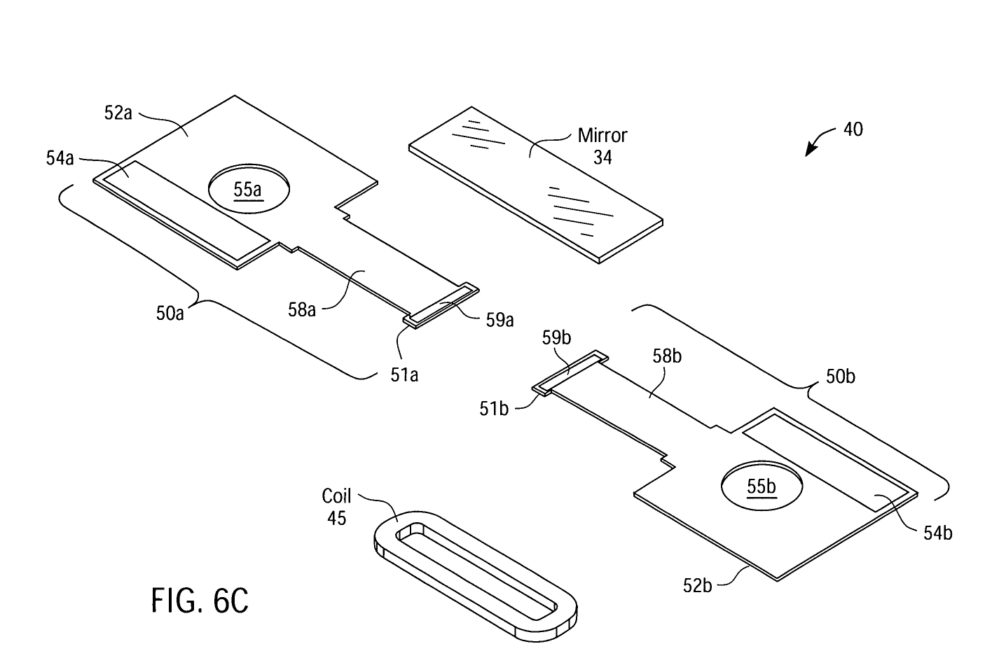

FIGS. 6A-C show side, bottom, and exploded top perspective views of the mirror-gimbal assembly 40 utilized in accordance with one embodiment of the present invention. The gimbal of FIG. 6 actually consists of two gimbal members 50a & 50b, each of which formed of a thin (e.g., 0.001 inches) flexible sheet-metal made from hard non-magnetic stainless steel material, such as 316 stainless steel, having high fatigue strength. Other materials providing similar properties may also be used. The material selected should allow the gimbal to rotate the attached mirror (or mirror-coil assembly) with a high rotational angle (e.g., +/−15°) over millions of movement cycles. The material may also be heat-treated. The sheet metal material is also preferably non-magnetic to prevent reluctance forces induced by the magnet in the actuator.

In the embodiment of FIG. 6, each gimbal member 50 comprises an elongated beam 58 connected to a rectangular or square end 52, which includes a circular hole 55 that may be used to mount the gimbal to actuator block 38 in accordance with the peg-in-hole mounting method previously described. Gimbal members 50 may be fabricated in a variety of shapes utilizing a variety of conventional methods, such as chemical etching, press cutting, milling, etc. Although a specific rectilinear cutout pattern is shown in these figures, it is understood that other embodiments may have different patterns or a different arrangement of beams, pads, etc., yet still provide rotational movement along the longitudinal axis in accordance with the present invention. In operation, beams 58a & 58b twist about their longitudinal axis to permit mirror 34 to rotate. In certain embodiments, beams 58 may be thinned by chemical etching to facilitate rotational flexing/twisting.

A tab 51 located at the end of beam 58 is bonded to the bottom of one end of mirror 34. For example, tab 51a is bonded to the left end, and tab 51b is bonded to the right end, of mirror 34 in the completed mirror-gimbal assembly of FIG. 6. Mirror 34 may be bonded to tabs 51 with adhesive. Alternatively, gold pads formed on the bottom ends of mirror 34 may be aligned with and bonded ultrasonically (e.g., 60-70 kHz) to gold pads formed on tabs 51 of gimbal members 50. Similarly, coil 45 may be adhesively or ultrasonically bonded to the bottom of mirror 34 with gold pads on the bottom of mirror 34 aligned to corresponding pads located on opposite ends of coil 45. (Reference numerals appended with the letter “a” denote elements of the left-hand gimbal member 50a, with the appended letter “b” denoting elements of the right-hand gimbal member 50b.)

Mirror 34 is made of a Pyrex® substrate that is coated with a reflective metal (e.g., aluminum, silver, gold, etc.) covered with a thin protective layer of silicon dioxide. In the exemplary embodiment shown, mirror 34 is about 2.2 mm wide, 0.2 mm thick and about 6.7 mm long.

FIG. 6 also shows coil 45 bonded to the bottom (i.e., backside) of mirror 34. In the embodiment of FIG. 6 coil 45 comprises an elongated “racetrack” shaped wire coil that is about the same size as mirror 34. Coil 45 is made of insulated 48 gauge copper wire and has approximately 70 turns. Current is delivered/conducted to coil 45 through gimbal members 50a & 50b. By way of example, contact pads 54a & 54b (˜1-2 microns of gold) may be formed on a top portion of respective ends 52a & 52b of gimbal members 50a & 50b using conventional lithographic printing methods. A seed layer of nickel (˜1-2 microns thick) may be added to contact pad 54 to facilitate soldering of wires (not shown in FIG. 6) to each of contact pads 54. Standard soldering or wire-bonding techniques may be used to bond wires to contact pads 54. In one direction, current to coil 45 flows into contact pad 54a, through gimbal beam 58a, coil 45, gimbal beam 58b, and out of contact pad 54b. It is appreciated that each end of the wrapped wire that comprises coil 45 is electrically connected with tabs 51. Ultrasonic bonding or soldering coil wires to gold pads located on the bottom of mirror 34 may be utilizing to achieve electrical connection.

In an alternative embodiment, coil 45 may be printed onto the backside of mirror 34 by plating or sputtering methods, e.g., utilizing standard semiconductor processing techniques. In yet another embodiment, mirror 34 may be integrated with gimbal members, with each being formed from a single wafer of silicon or thin piece of metal (e.g., steel). In still other embodiments, instead of utilizing two separate gimbal members, the gimbal may be fabricated from a single piece of thin material having ends connected by an elongated beam. In this latter embodiment, the mirror and/or coil may be bonded onto (or integrated with) the single piece of material.

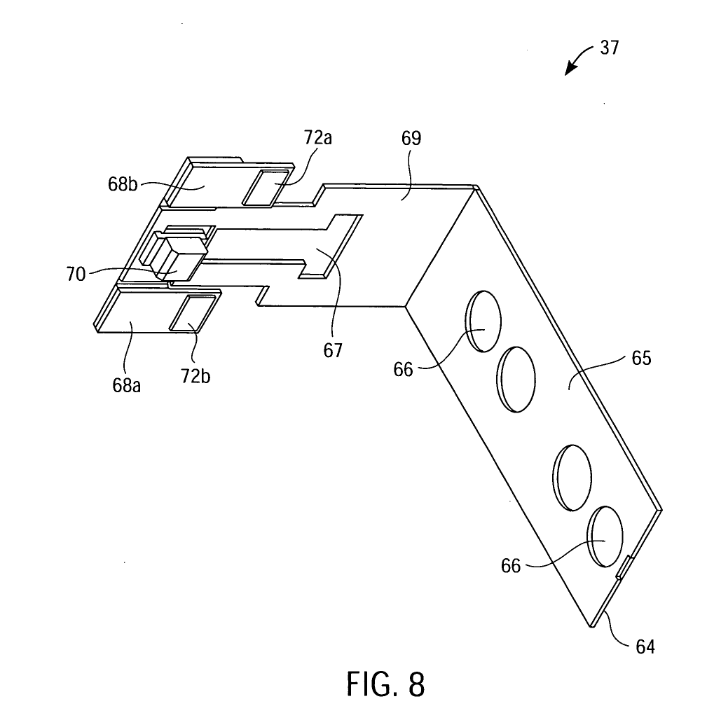

Servo control of the actuator assemblies is achieved through position feedback of mirrors 33 & 34. FIG. 8 is a bottom perspective view of detector bracket assembly 37 utilized for position feedback in accordance with one embodiment of the present invention. Assembly 37 includes an L-shaped rigid bracket member 64, one end of which comprises a flat, side plate 65 having two or more holes 66 used for aligned mounting to corresponding pegs protruding from the one side of actuator block 38 (see FIG. 4). The other end of bracket member 64 comprises a top plate 69 that supports an LED 70. Note that top plate 69 includes an optional opening 67 that reduces weight and which may be useful for permitting visual inspection of the underlying mirror-gimbal assembly.

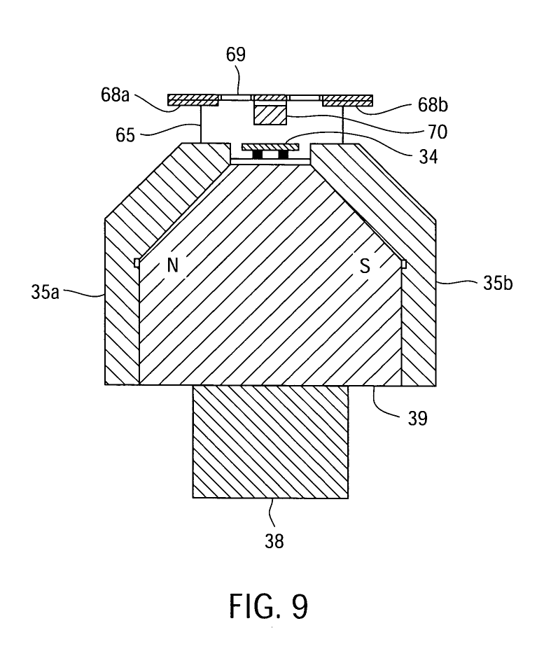

In one embodiment of the completed actuator assembly, LED 70 is suspended directly over about 25% of one end of the mirror mounted on top of actuator block 38. A pair of photodetectors 68a & 68b is mounted to top plate 69 on opposite sides of LED 70. FIG. 9 is a cross-sectional side view (taken through cut lines A-A′) of actuator assembly 28 showing the position of LED 70 and photodetectors 68a & 68b relative to mirror 34. In one implementation, photodetectors 68 comprise part number S-4VL manufactured by UDT Sensors, Inc., of Hawthorne, Calif.; and LED 70 comprises part number BL-HF035A-TR manufactured by American Bright Optoelectronics Corp., of Brea, Calif. Solder pads 72a & 72b allow a wire to be connected to each of respective photodetectors 68a & 68b. Each photodetector 68 produces an electrical signal proportional to the intensity of the incident light.

During operation LED 70 produces light that is reflected off the surface of mirror 34 (or 33). In certain embodiments, the light from LED 70 may be focused or otherwise directed toward the mirror at side angles (e.g., 30-45°) depending on the particular LED used and the location of photodetectors 68. In any case, the intensity of the reflected light is detected by each photodetector 68. As the mirror rotates in a particular direction, the intensity of light decreases on one side of LED 70 and increases on the other side. This difference in light intensity on opposite sides of LED 70 is sensed by photodetectors 68. Together, photodetectors 68a & 68b produce a rotational position feedback signal that is input to servo control circuitry, details of which are discussed below.

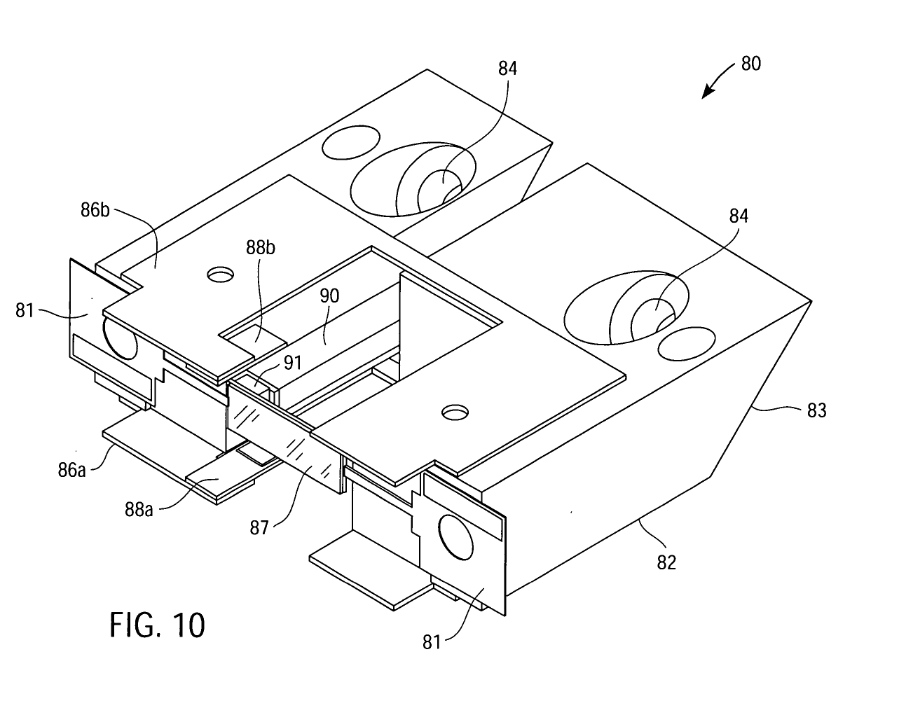

FIG. 10 is a perspective view of another embodiment of an actuator assembly 80 in accordance with the present invention. Actuator assembly 80 comprises a block 82 of electrically non-conductive material having a beveled (45°) bottom surface 83 and a pair of mounting holes 84 for securing assembly 80 to the base of the laser assembly. Ordinary securing methods, e.g., screws, rivets, pins, etc., may be employed. In this embodiment, a mirror-gimbal assembly 81 is attached to opposite ends of a top surface of block 82 for rotationally suspending a mirror 87 (with backside mounted coil 85) directly above a permanent magnet (not shown). Rotation of mirror-coil assembly 87 is achieved in the same manner as that described in conjunction with previous embodiments.

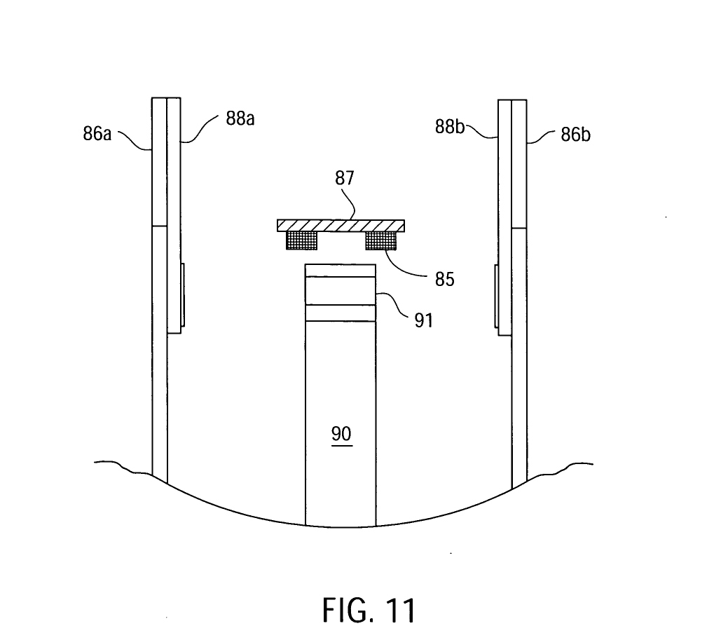

Position feedback is achieved in the embodiment of FIG. 10 through the use of a pair of photodetectors 88a & 88b mounted to mounting plates 86a & 86b, respectively attached to opposite sides of block 82. A LED 91 is mounted on the top of a pedestal 90 underneath one end of mirror 87, as best seen in the cross-sectional side view of FIG. 11. In this embodiment, light produced by LED 91 is blocked by the bottom of mirror 87, but passes through the openings on both sides of mirror 87. This arrangement causes shadows to be cast on the vertically mounted photodetectors 88, which are laterally spaced apart on opposite sides above the top, reflective surface of mirror 87. Depending on the rotational angle of mirror 87, the shadow (or light intensity) sensed by one photodetector 88 is greater relative to that sensed by the photodetector positioned on the opposite side of mirror 87. The difference between the light intensities sensed by the two photodetectors is a measure of the rotation of mirror 87. The signal output from photodetectors 88 may be input to a servo control circuit.

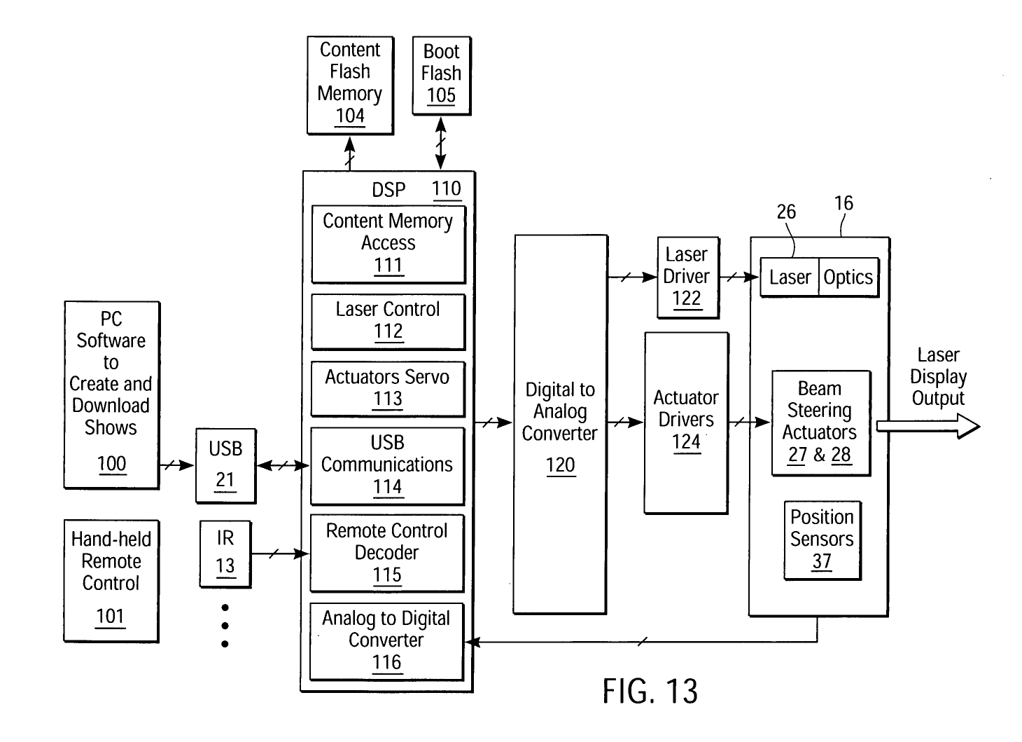

With reference now to FIG. 13, there is shown a block diagram of the electronics architecture according to one embodiment of the present invention. FIG. 13 illustrates personal computer (PC) based software 100 for creating and downloading display programs or shows into the laser projection display apparatus of the present invention through USB port 21, coupled to USB communications block 114 of digital signal process (DSP) 110. As explained previously, display programs may also be downloaded to the display device through a variety of other connections and methods, including wireless connection, Ethernet, serial interface, etc. Alternatively, the display device of the present invention may include one or more drive units, such as hard magnetic disc, floppy, CD-ROM drive, or DVD disk drive units for receiving display program content. Input commands may be entered by a hand-held remote control device 101 through IR port 13, which is coupled to a remote control decoder 115, which may comprise software or firmware embedded within DSP 110. Input commands may also be input through an alternative keypad source, such as a conventional keypad incorporated into or mounted onto the device enclosure.

Content memory access is managed by block 111 of DSP 110, which interfaces with content flash memory 104 and boot flash memory (e.g., EEPROM) 105. Downloaded program shows or display images created with pushbutton keypad strokes may be stored in the display device in flash memory unit 104 coupled to DSP 110. In an alternative embodiment, flash memory 104 and/or boot flash 105 may be embedded within DSP 110.

Position feedback signals generated by the photodetectors associated with the laser beam steering actuators are input into DSP 110, which, in one implementation, comprises part number ADSP 21990 manufactured by Analog Devices Corporation of Norwood, Mass. As shown in FIG. 13, position sensor block 37 of laser assembly 16 produces position feedback signals coupled to analog-to-digital (A/D) converter 116 embedded in DSP 110. Feedback power and light intensity signals from laser 26 are also coupled to DSP 110 to control laser light intensity and for automatic power control. A/D converter 116 converts the analog feedback signals received from actuator assemblies 27 & 28 and laser assembly 16, and converts them into digital signals for processing by DSP 110.

By way of example, in order to move the laser beam to a new position responsive to the content of a downloaded program, DSP 110 performs calculations and generates digital signals that are output to a digital-to-analog (D/A) converter 120. D/A converter 120 converts the digitals signals received from DSP 110 into analog signals coupled to actuator drivers 124 and laser driver 122. These analog signals are used by drivers 122 and 124 to generate currents (i.e., coil currents) that are used to change the rotational position of the mirrors associated with actuators 27 & 28 of laser assembly 16, as well as control the power and intensity of laser 26. Actuator servo control is shown occurring in block 113 of DSP 110. Similarly, control of laser 16 (e.g., intensity and power) is performed in block 112.

It should be understood that in the embodiment shown, laser 26 includes a photodetector that produces a signal useful for automatic power control. According to the architecture of the present invention, automatic power control, laser intensity control, and on/off switching of the laser diode are performed by DSP 110. Furthermore, control of each of these functions is integrated with program content and servo actuation of the mirrors. Laser intensity and power feedback signals are coupled to A/D converter 116 of DSP 110, which may be determine, for example, that the content program requires the laser beam to turn off and move to a new position before turning on again. To perform this operation, laser control block 112 of DSP 110 outputs signals through D/A converter 120 and laser driver 122 that turns laser 26 off, and then turns laser 26 back on again at the precise time that position sensors 37 indicate to DSP 110 that the mirrors of actuators 27 & 28 are at the desired rotational position. Thus, on/off switching of the laser diode is synchronized with the servo loop that controls actuation of the mirrors, all of which is based on program content.

According to the present invention, the output power of laser 26 may also be controlled to vary laser intensity based upon show content. For example, when projecting a real-time animated show that moves rapidly from one image to another image, or one that has many display points or pixels, DSP 110 may increase the light intensity of the laser beam to avoid dimming of the projected display. Conversely, when projecting a static image or one that changes slowly, DSP 110 may decrease the intensity of the laser beam. In other words, DSP 110 controls the laser output, both in terms of light intensity and on/off switching, depending upon the execution instructions of the display program, i.e., show content. In the embodiment of FIG. 13, DSP 110 controls the servo actuation of mirrors 33 & 34, light intensity and on/off control of laser 26, as well as content control for the projection shows in an integrated manner. The electronics architecture of the present invention thus integrates servo control of laser light switching/intensity and mirror position with program content (firmware), all in a single processor to greatly improves performance over prior art laser projectors.

It should be understood that elements of the present invention may also be provided as a computer program product which may include a machine-readable medium having stored thereon instructions which may be used to program a computer (or other electronic device) to perform a process. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, elements of the present invention may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection).

Additionally, although the present invention has been described in conjunction with specific embodiments, numerous modifications and alterations are well within the scope of the present invention. Accordingly, the specification and drawings are to be regarded in an illustrative rather than a restrictive sense.

1. A laser projection display apparatus comprising:
a laser that emits a light beam;
actuator means for steering the light beam to generate two-dimensional display images, the actuator means including first and second mirrors, each of the mirrors being suspended by a gimbal, each of the mirrors rotating responsive to a current in the presence of a magnetic field;
means for integrated, synchronous control of the actuator means and on/off switching of the laser based on content of a display program.

2. The laser projection display apparatus of claim 1 wherein the control means comprises a processor coupled to the laser and the actuator means, the processor implementing actuator servo control and laser servo control feedback loops.

3. The laser projection display apparatus of claim 2 wherein the processor further provides integrated, synchronous control of light beam intensity based on the content of the display program.

4. The laser projection display apparatus of claim 1 further comprising a means for downloading and storing the display program.

5. The laser projection display apparatus of claim 1 further comprising a means for inputting commands to the control means.

6. The laser projection display apparatus of claim 1 wherein the actuator means includes a coil attached to a backside of each of the mirrors, the coil having a longitudinal axis that is perpendicular to a direction of magnetization of the magnetic field such that a rotational force is generated upon application of the current to the coil.

7. The laser projection display apparatus of claim 1 wherein the magnetic field is generated by a magnet having a trapezoidal-shaped upper portion with a narrow top surface of the magnet being disposed directly beneath the coil.

8. A laser projection display apparatus comprising:
a laser that emits a light beam;
actuator means for steering the light beam to generate two-dimensional display images, the actuator means including first and second mirrors, each of the mirrors being suspended by a gimbal, each of the mirrors rotating responsive to a current in the presence of a magnetic field;
a processor to execute a display program, the actuator means and the laser being synchronously controlled by signals generated by the processor responsive to instructions of the display program.

9. The laser projection display apparatus of claim 8 wherein the processor implements actuator servo control and laser servo control feedback loops.

10. The laser projection display apparatus of claim 8 wherein the processor provides integrated, synchronous control of intensity, on/off switching, and position of the light beam based on the instructions of the display program.

11. The laser projection display apparatus of claim 8 further comprising:
an interface coupled to the processor for downloading of the display program; and
a memory coupled to the processor to store the display program.

12. The laser projection display apparatus of claim 11 wherein the interface includes an infrared port to receive input commands and display content.

13. The laser projection display apparatus of claim 8 wherein the actuator means includes a coil is attached to a backside of each of the mirrors, the coil having a longitudinal axis that is perpendicular to a direction of magnetization of the magnetic field such that a rotational force is generated upon application of the current to the coil.

14. The laser projection display apparatus of claim 1 wherein the magnetic field is generated by a magnet having a trapezoidal-shaped upper portion with a narrow top surface of the magnet being disposed directly beneath the coil.

15. A laser projection display apparatus comprising:
an enclosure;
a laser assembly housed in the enclosure, the laser assembly including:
a base;
a laser mounted to the base, the laser emitting a light beam in a first direction;
a first actuator assembly mounted to the base, the first actuator assembly having a first mirror positioned to reflect the light beam emitted from the laser in a second direction, the second direction being approximately perpendicular to the first direction;
a second actuator assembly mounted to the base, the second actuator assembly having a second mirror positioned to further reflect the light beam in a third direction through an opening of the enclosure, the third direction being approximately perpendicular to both the first and second directions;
the first and second mirrors each being rotationally mounted to a gimbal;
rotation of the first and second mirrors causing the light beam to be projected in a two-dimensional scan; and
a processor to generate signals that control the laser and rotation of the first and second mirrors of the actuator assemblies responsive to content of a display program.

16. The laser projection display apparatus of claim 15 wherein the processor implements actuator servo control and laser servo control feedback loops.

17. The laser projection display apparatus of claim 15 wherein the processor provides synchronous control of intensity, on/off switching, and the two-dimensional scan of the light beam based on the content of the display program.

18. The laser projection display apparatus of claim 15 further comprising:
an interface coupled to the processor for downloading of the display program; and
a memory coupled to the processor to store the display program.

19. The laser projection display apparatus of claim 18 wherein the interface includes an infrared port to receive input commands and display content.

20. The laser projection display apparatus of claim 15 wherein each of the first and second actuator assemblies includes a magnet, with a coil being attached to a backside of each of the mirrors, the coil having a longitudinal axis that is perpendicular to a direction of magnetization of a magnetic field produced by the magnet such that a rotational force is generated upon application of current to the coil.

21. The laser projection display apparatus of claim 15 wherein the magnet has a trapezoidal-shaped upper portion with a narrow top surface of the magnet being disposed directly beneath the coil.
